(19) United States
(12) Patent Application Publication
(10) Pub. No.: US 2026/0241830 A1
(43) Pub. Date: Aug. 20, 2026

(54) Charging Controller for a Vehicle

(71) Applicant: Bayerische Motoren Werke Aktiengesellschaft, Muenchen (DE)

(72) Inventors: Florian Kotsch, Muenchen (DE); Harald Hofmeier, Eching (DE); Holger Wierschin, Markt Indersdorf (DE)

(21) Appl. No.: 19/164,934

(22) PCT Filed: Jan. 31, 2024
(86) PCT No.: PCT/EP2024/052379

§ 371 Date: Sep. 12, 2025

(30) Foreign Application Priority Data
Mar. 20, 2023 (DE) 10 2023 106 845.8

(51) Int. Cl. B60L 53/66; B60L 53/30; B60L 53/65

(52) U.S. Cl. CPC B60L 53/665; B60L 53/305; B60L 53/65

(57) ABSTRACT

A charging controller for a vehicle includes a control circuit and at least one interface for communication with a charging infrastructure. The control circuit is configured to process a communication message from the charging infrastructure. The control circuit is further configured to determine at least one identifier of an operator of the charging infrastructure based on the communication message, and determine a selection of a charging contract from a plurality of charging contracts stored in the charging controller based on the operator of the charging infrastructure. Additionally, the charging circuit is configured to authenticate the charging controller with respect to the charging infrastructure based on the selected charging contract.

### CROSS-REFERENCE TO RELATED APPLICATIONS

The present application is the U.S. national phase of PCT Application PCT/EP 2024/052379 filed on Jan. 31, 2024, which claims priority of German patent application No. 10 2023 106 845.8 filed on Mar. 20, 2023, the entire contents of which are incorporated herein by reference.

### FIELD

The present disclosure relates to a charging controller, a device for determining a selection of a charging contract, and a vehicle having a charging controller.

### BACKGROUND

Plug & Charge (a charging standard for charging electric vehicles) is based on the ISO 15118 industry standard. Using Plug & Charge, drivers of electric vehicles, such as battery electric vehicles (BEV) or hybrid vehicles (also referred to as PHEV, Plug-in Hybrid Electric Vehicle, a motor vehicle having a hybrid drive, of which the battery can be charged by the engine and by plugging in a charging plug) can be authenticated at public charging points only by plugging in the charging cable and thereby charging the vehicle battery. The authentication takes place with a digital contract certificate in accordance with the standard. The contract certificate contains, inter alia, the contract number. The charging point operator (CPO) can bill for the charging procedure with this number via the existing roaming platforms with the contract provider (EMP or MO, Electro Mobility Provider or Mobility Operator, often the same as the EMP), or can bill the customer directly (if the CPO is at the same time the contract provider). The mode of operation will be described in detail below.

According to the current status of the standard (ISO 15118-2), the vehicle can transmit only one certificate to the charging point; in many systems, only one certificate is therefore held on the vehicle. If more than one certificate is installed on the vehicle, the user can specify, for example, which certificate is currently being used. This certificate is stored on the charging controller and is transmitted to the charging point when the charging procedure is initiated. In some cases, this can result in incompatibilities if the charging point operator does not support the certificate (e.g. because the operator does not offer roaming, or because a contract, and therefore the certificate, function only on a charging point of the employer, and a different contract functions only on public charging points), or can result in higher charging costs if the driver of the vehicle has a plurality of contracts which incur different costs.

The need exists for an improved system and method for authenticating a charging controller with respect to a charging infrastructure.

### SUMMARY

The present disclosure is relates to the selection of a charging contract that can be used for authentication with respect to a charging infrastructure that is made automatically during the initialization of the charging procedure. For this purpose, in the present disclosure, the communication message which the charging infrastructure transmits during the connection set-up is analyzed in order to extract at least one identifier. This at least one infrastructure is then analyzed to draw conclusions concerning the operator of the charging infrastructure based on the at least one identifier. This is then used in turn to automatically select a charging contract and to authenticate the charging controller with respect to the charging infrastructure on the basis of the charging contract. This makes it possible, on the one hand, to avoid the aforementioned incompatibilities, and, on the other hand, to automatically select the contract which incurs the lowest costs.

One aspect of the present disclosure relates to a charging controller for a vehicle. The charging controller comprises at least one interface for communication with a charging infrastructure. The charging controller comprises a control circuit designed to process a communication message from the charging infrastructure. The control circuit is designed to determine at least one identifier of an operator of the charging infrastructure based on the communication message. The control circuit is designed to determine, based on the operator of the charging infrastructure, a selection of a charging contract from a plurality of charging contracts stored in the charging controller. The control circuit is designed to authenticate the charging controller with respect to the charging infrastructure based on the selected charging contract. This makes it possible, on the one hand, to avoid the aforementioned incompatibilities, and, on the other hand, to automatically select the contract which incurs the lowest costs.

The communication message can be received, for example, during a connection set-up between the charging infrastructure and the charging controller. This enables the automated selection during the connection set-up, as specified, for example, in the ISO 15118-2 or ISO 15118-20 standards, without the charging infrastructure having to transmit more detailed information to support the selection of the charging contracts, and without the connection-setup being (unduly) delayed as a result.

An identifier can refer to the operator of the charging infrastructure at various places within or on the communication message. Such an identifier can be extracted, for example, from a digital certificate that is used to set up a transport layer security (TLS) encryption. The control circuit can be designed accordingly to extract the at least one identifier from a leaf certificate that is used by the charging infrastructure, or from a different certificate of a certificate chain which comprises the leaf certificate. This leaf certificate has information allowing the conclusion to be drawn concerning the operator. Furthermore, information can also be extracted from other certificates of the certificate chain, allowing a conclusion to be drawn concerning the operator of the charging infrastructure, e.g. from an issuer field, or from a subject field of the respective certificate. Both the leaf certificate and the certificate chain thus allow conclusions to be drawn concerning the operator of the charging infrastructure.

For example, at least one from a Supply Equipment Communication Controller Identifier (SECCID,) and a Charge Point Identifier (CPID) can be extracted from the leaf certificate and can be used as at least one identifier. These identifiers can be used to identify the operator of the charging infrastructure.

Alternatively or additionally, the at least one identifier can comprise an identifier with which the charging infrastructure presents itself to the charging controller. The at least one identifier can comprise, for example, an Electric Vehicle Supply Equipment Identifier (EVSEID). The EVSEID can also be used in some cases to identify the operator of the charging infrastructure.

In practical implementations, it has become evident that the identifiers transmitted by the charging infrastructure are used differently by the different operators. As a result, it is sometimes not possible to reliably draw a conclusion concerning the operator from a single identifier. The control circuit can be designed, for example, to determine a plurality of identifiers based on the communication message and, depending on the operator, to use one or more of the identifiers to identify the operator. This increases the reliability of the identification of the operator.

A charging contract can then be selected based on the operator. The selection can be determined, for example, on the basis of a data structure (such as e.g. a decision tree or a case distinction). A charging contract that is to be selected can be defined in the data structure for a plurality of operators. This enables real-time selection of charging contract, with low computing complexity. A charging contract which is to be selected if no charging contract to be selected is defined for an operator can be defined in the data structure. With the multiplicity of possible operators and/or with the emergence of new operators, this enables the selection of a charging contract (e. g. a charging contract of an operator having many roaming agreements) which is used by default to enable the performance of the charging procedure despite an unknown operator.

In the present disclosure, the actual selection of the charging contract can be carried out on the charging controller or on a different controller in the vehicle (or even on a server in the backend). In other words, the selection of the charging contract can be carried out by the control circuit. This enables a determination of the selection with little latency. However, the memory available in the charging controller is usually limited, so that, with a multiplicity of possible operators, it is possible that not every operator can be supported here. Alternatively, the determination of the selection can comprise providing information to a remote station relating to the at least one identifier, and receiving information from the remote station relating to the charging contract to be selected. The remote station can be a further controller of the vehicle or a backend server. As a result, for example, a remote station having more storage space to cover a larger number of operators or to take into account other criteria (off-peak or peak electricity, special offers) or more recent information relating to the operators can take charge of the selection, at the expense of higher latency and/or higher implementation complexity.

In some cases, e.g. in the charging communication in accordance with ISO 15118-20, the charging infrastructure can also provide information indicating which mobile operators are supported by the charging infrastructure. This information can then be used to further improve the selection, e.g. in cases where the operator is not known. In other words, the control circuit can further be designed to receive a list of supported mobility operators from the charging infrastructure and to determine the selection of the charging contracts further based on the list of supported mobility operators. This enables a further improvement in the selection, particularly in cases where the operator of the charging infrastructure is not known to the charging controller or cannot be determined.

In some cases, it may occur, despite the selection of the charging contract based on the operator of the charging infrastructure, that the authentication fails. In these cases, information relating thereto can be transmitted to a backend server in order to improve the selection criteria in future. The control circuit can further be designed, for example, at least in the case where the authentication fails, to transmit information relating to the at least one identifier, the selected charging contract, and the success or failure of the authentication to a backend server.

The disclosure herein is applicable, in particular, in connection with the Plug & Charge charging standard. The charging contracts and communication with the charging infrastructure can be based accordingly on the ISO 15118 standard. However, the basic concept is also selectable on comparable charging communication standards.

A further aspect of the present disclosure relates to a corresponding method for a charging controller for a vehicle. The method comprises processing a communication message from the charging infrastructure. The method comprises determining at least one identifier of an operator of the charging infrastructure based on the communication message. The method comprises determining a selection of a charging contract from a plurality of charging contracts stored in the charging controller based on the operator of the charging infrastructure. The method comprises authenticating the charging controller with respect to the charging infrastructure based on the selected charging contract. The method can be carried out, for example, by the charging controller.

A further aspect of the present disclosure relates to a corresponding program having a program code to carry out the method for the charging controller when the program code is executed on a computer, a processor, a control module, a control circuit or a programmable hardware component, e.g. of the charging controller.

A further aspect of the present disclosure relates to a device for determining a selection of a charging contract. The device comprises an interface for communicating with a charging controller of a vehicle. The device comprises a control circuit designed to receive information relating to at least one identifier of an operator of a charging infrastructure from the charging controller. The control circuit is designed to determine a selection of a charging contract from a plurality of charging contracts stored in the charging controller based on the operator of the charging infrastructure. The control circuit is designed to provide the charging controller with information relating to the charging contract to be selected. The selection of the charging contract can be relocated away from the charging controller by implementing the device in a different controller (e. g. a head unit) of the vehicle, or in a backend server.

A further aspect of the present disclosure relates to a corresponding method for determining a selection of a charging contract. The method comprises receiving information relating to at least one identifier of an operator of a charging infrastructure from the charging controller. The method comprises determining a selection of a charging contract from a plurality of charging contracts stored in the charging controller based on the operator of the charging infrastructure. The method comprises providing the charging controller with information relating to the charging contract to be selected. The method can be carried out, for example, by a controller of the vehicle or by a backend server.

A further aspect of the present disclosure relates to a corresponding program having a program code to carry out the method for determining a selection of a charging contract when the program code is executed on a computer, a processor, a control module, a control circuit or a programmable hardware component.

### BRIEF DESCRIPTION OF THE DRAWINGS

Exemplary embodiments are explained in detail below with reference to the attached figures, in which:

FIG. 1a shows a schematic diagram of a charging controller;

FIG. 1b shows a flow diagram of a method for a charging controller;

FIG. 2a shows a schematic diagram of a device for determining a selection of a charging contract;

FIG. 2b shows a flow diagram of method for determining a selection of a charging contract;

FIG. 3 shows a schematic diagram of Plug & Charge from a technical perspective;

FIG. 4 shows a simplified representation of the technical infrastructure for the use of Plug & Charge; and

FIG. 5 shows a diagram of an example of fields of a certificate.

### DESCRIPTION

Some examples will now be described in more detail with reference to the attached figures. However, further possible examples are not restricted to the features of these detailed described embodiments. These embodiments can have modifications of the features, as well as equivalents and alternatives to the features. Furthermore, the terminology that is used herein to describe specific examples is not intended to be restrictive for further possible examples.

In the entire description of the figures, identical or similar reference signs relate to identical or similar elements or features which can be implemented in each case identically or in modified form while providing an identical or similar function. The thickness of lines, layers and/or areas can be exaggerated in the figures for illustrative purposes.

If two elements a and b are combined using an “or”, this is to be understood to mean that all possible combinations are disclosed, i.e. A only, B only, as well as A and B, unless expressly defined otherwise in individual cases. The phrase “at least one of A and B” or “A and/or B” can be used as an alternative wording for the same combinations. The same applies to combinations of more than two elements.

If a singular form, e.g. “a, an, one”, and “the”, is used, and the use of only a single element is neither explicitly nor implicitly defined as mandatory, further examples can also use a plurality of elements to implement the same function. If a function is described below as being implemented using a plurality of elements, further examples can implement the same function using a single element or a single processing entity. It is furthermore obvious that the terms “comprises”, “comprising”, “has” and/or “having” are used to describe the presence of the indicated features, integers, steps, operations, processes, elements, components and/or a group thereof, but do not exclude the presence or the addition of one or more other features, integers, steps, operations, processes, elements, components and/or a group thereof.

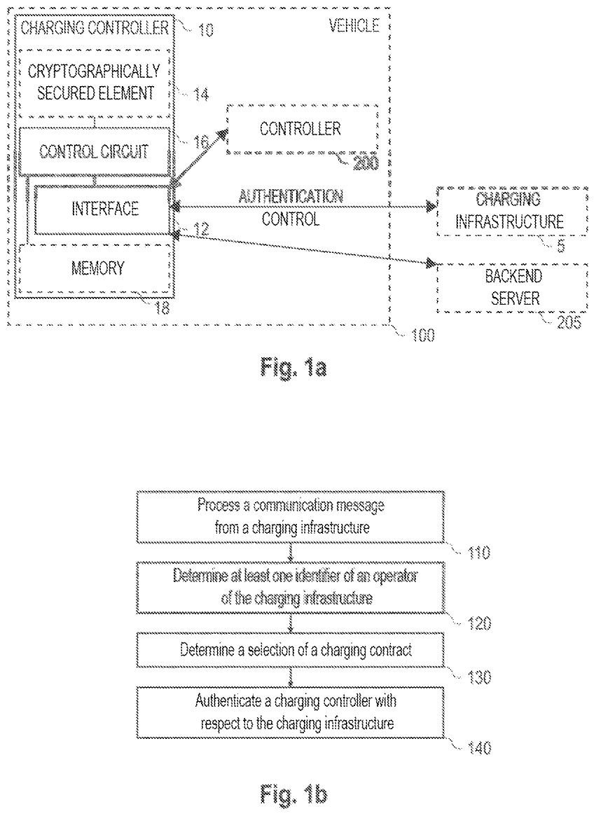

FIG. 1a shows a schematic diagram of a charging controller 10 for a vehicle 100, wherein the charging controller 10 is part of the vehicle 100. The charging controller comprises at least one interface 12 for communicating with a charging infrastructure 5 (e. g. a charging point), e.g. using power line communication. In some examples, the at least one interface 12 comprises an interface for communicating with a different controller 200 of the vehicle 100 (e.g. a head unit of the vehicle), at least one interface for communicating with a server 205, e. g. via a telematics connection/mobile radiocommunication connection. The charging controller 10 shown in Fig. la comprises a cryptographically secured element 14, e.g. a “Secure Element” or “Trusted Execution Environment”. The charging controller 10 comprises control circuit 16 which is coupled to the cryptographically secured element 14 and the at least one interface 12. The cryptographically secured element can, for example, be a part of the control circuit 16 or a separate component. The charging controller 10 further optionally comprises a memory 18 which is coupled to the control circuit 16.

Fig. la further shows a system comprising the charging controller 10 and the controller 200. Fig. la further shows a system comprising the charging controller 10 and the server 205. Fig. la further shows a system comprising the charging controller 10 and the controller 200 and the server 205.

The control circuit 16 is designed to process a communication message from the charging infrastructure. The control circuit 16 is designed to determine at least one identifier of an operator of the charging infrastructure based on the communication message. The control circuit 16 is designed to determine a selection of a charging contract from a plurality of charging contracts stored in the charging controller based on the operator of the charging infrastructure. The control circuit 16 is designed to authenticate the charging controller with respect to the charging infrastructure based on the selected charging contract.

FIG. 1b shows a flow diagram of a corresponding method for the charging controller 10. The method comprises processing 110 the communication message from the charging infrastructure. The method comprises determining 120 the at least one identifier of an operator of the charging infrastructure based on the communication message. The method comprises determining 130 a selection of the charging contract from the plurality of charging contracts stored in the charging controller based on the operator of the charging infrastructure. The method comprises authenticating 140 the charging controller with respect to the charging infrastructure based on the selected charging contract.

The charging controller, the corresponding method and a corresponding computer program are described below with reference to the charging controller. Features that can be described in connection with the charging controller can similarly be applied to the corresponding method or computer program.

In the charging communication in accordance with the Plug & Charge standard, charging contracts (also known as contract certificates) are used to authenticate the charging controller with respect to the charging infrastructure (e.g. a charging point). These charging contracts are issued under the terms of a contract between the driver/user of the vehicle and a mobility operator, and are used by the operator of the charging infrastructure to bill for the supplied charging current. To do this, the mobility operator concludes a contract with the operator of the charging station (insofar as the mobility operator and the operator of the charging station are not the same entity), setting out the costs that are incurred by the mobility operator when the charging infrastructure is used by a customer of the mobility operator. The mobility operator in turn bills the customer for the services provided by the operator of the charging station. However, not all mobility operators have concluded contracts with all charging station operators, so that a use of a charging infrastructure is not possible with all contracts. Furthermore, prices vary depending on the contract between the mobility operator and the customer and the mobility operator and the charging station operator, in some cases substantially. In current implementations of Plug & Charge (in accordance with ISO 15118-2), only one certificate is often installed for use with Plug & Charge. In this case, selection by the user does not apply. If more than one certificate is installed on the vehicle, the user can specify, for example, which certificate is currently being used. If the user of the vehicle has a plurality of contracts with a plurality of mobility operators, and therefore also a plurality of charging contracts, the user is therefore required to select the appropriate contract for the respective charging station. The present disclosure extensively automates this selection, and focuses on a charging-station-based contract selection, e.g. in connection with Plug & Charge.

In order to at least ensure that the charging contract that is used is also supported by the charging station operator, the current version ISO 15118-20 of the standard supports the feature whereby a charging station notifies the connected vehicle by means of the SupportedProvidersListType data structure of the contract providers that are supported. This function enables the vehicle to use an appropriate certificate, insofar as an appropriate certificate is installed. This provides a partial remedy in that the vehicle can select at least one accepted contract. However, the standard provides no mechanism, for example, for dealing with more than one accepted contract. Similarly, the currently widespread stations cannot use this mechanism according to 15118-2. A subsequent switch to ISO 15118-20 may be possible for some charging stations. However, vehicles cannot subsequently be upgraded to ISO 15118-20 due to various limitations, and for this reason ISO 15118-2 will also have to be supported by all market participants for the foreseeable future. There are furthermore usage scenarios from this perspective of the user in which the user would like to use a specific contract for a specific charging station operator since, for example, the user obtains better conditions with this contract with this provider than with the otherwise favored standard contract.

The present disclosure involves identification of the operator by means of a unique identifier of the charging station which is transmitted during the charging communication. To do this, the charging controller processes the communication message from the charging infrastructure. This communication message can, for example, be a communication message which is exchanged at the start of the communication between the charging controller and the charging infrastructure (i.e. charging point), e.g. a message from the charging infrastructure to the charging controller during the connection set-up. The communication message may have been received, for example, during a connection set-up between the charging infrastructure and the charging controller. The communication between the charging infrastructure and the charging controller can be based, for example, on the ISO 15118 standard and, in particular, on the ISO 15118-2 or ISO 15118-20 standard. The charging contracts mentioned here can also be based on the ISO 15118 standard, and, in particular, on the ISO 15118-2 or ISO 15118-20 standard.

The control circuit is designed to determine at least one identifier of an operator of the charging infrastructure based on the communication message. Various sources can be considered here. These sources include, for example, the EVSEID (Electric Vehicle Supply Equipment Identifier). In other words, the at least one identifier can comprise the EVSEID. The EVSEID is transmitted from the charging station in accordance with the standard as part of the SessionSetupRes. Alternatively or additionally, the SECCID (Supply Equipment Communication Controller Identifier) and/or the CPID (Charge Point Identifier) can be used, which are in each case part of the leaf certificate. The SECCID is a part of the SECC (Supply Equipment Communication Controller) leaf certificate in accordance with ISO 15118-20, and the CPID is part of the leaf certificate in accordance with ISO 15118-2. The control circuit can be designed accordingly to extract the at least one identifier from the leaf certificate, which is used by the charging infrastructure. In this case, the at least one identifier can comprise at least one from the Supply Equipment Communication Controller Identifier, SECCID, and the Charge Point Identifier, CPID. In some cases, the CPID can also match the EVSEID. Both the EVSEID and the SECCID contain a 3-digit alphanumeric EVSE (Electric Vehicle Supply Equipment) operator ID (identifier) and a 2-digit country code which (together) identify the charging station operator.

Moreover, the leaf certificate comprises, along with the SECCID or CPID, additional information which is further contained in other certificates of a certificate chain which comprises the leaf certificate, allowing conclusions to be drawn concerning the operator. FIG. 5 shows examples of the fields of such a certificate. In particular, one or more of the “country”, “organization”, and “common name” fields of the issuer and/or subject segments can be used to identify the operator of the charging infrastructure. The CPID corresponds, for example, to the common name, if the certificate is the leaf certificate in accordance with ISO 15118-2. The control circuit can be designed accordingly to extract the at least one identifier from a certificate of the certificate chain comprising the leaf certificate, which is used by the charging infrastructure. The identifier can comprise, for example, one or more of the above-mentioned fields.

In a charging controller compliant with ISO 15118-2/-20, the EVSEID from the SessionSetupRes can be stored temporarily in a buffer memory. In addition, the charging controller can extract the CPID or the SECCID from the SECC leaf certificate and store it temporarily in a buffer memory. Experiments have shown that the EVSEID from the SessionSetupRes is not a reliable datum Europe, and for this reason it may be appropriate, additionally or alternatively, to use the information from the certificates, insofar as these certificates are considered to be more reliable. The control circuit can be designed accordingly to determine a plurality of identifiers based on the communication message (e.g. EVSEID and CPID, or EVSEID and SECCID), and, depending on the operator, to use one or more of the identifiers to identify the operator. The decision to use a specific datum for the automated contract selection can be defined by means of configuration parameters. Alternatively, an algorithm on the charging controller can decide which datum is most likely to be correct, and use it for the procedure that follows.

### The Control Circuit Is Designed to Determine the

selection of the charging contract from the plurality of charging contracts stored in the charging controller based on the operator of the charging infrastructure. The selection can be determined, for example, based on a data structure, wherein a charging contract to be selected is defined in the data structure for a plurality of operators. The data structure can be stored, for example, in the memory 18. A list of EMAIDs (E-Mobility Account Identifiers) is used below as an example of a data structure. However, a database or decision tree can also be used as a data structure instead of the list. The examples cited in connection with the list can also be transferred accordingly to a database or decision tree. In the examples, the respective EMAID represents the charging contract to be selected, i.e. the charging contract to be selected is designated by the associated EMAID.

### The Charging Controller, or a Different Entity, Can

further store a list which represents the specification for the automated contract selection. Every list entry can comprise, for example, at least a two-digit country ID, a three-digit operator ID, and the EMAID. In addition, the list can comprise one or more EMAIDs, which serve as fallback contracts. In other words, a charging contract (the one or more fallback contracts) can further be defined in the data structure and can be selected if no charging contract to be selected is defined for an operator.

Based on the identified operator, for example by means of a predefined list containing the contract ID (EMAID, E-Mobility Account Identifier) and the EVSE operator ID (identifying the operator), the vehicle can be notified in respect of which contract (EMAID) with which operator (EVSE operator ID) is to be automatically selected and used. If a vehicle is then connected to a charging station which supports Plug & Charge, the charging controller first verifies, for example, the EVSEID/SECCID/CPID (i.e. the at least one identifier) temporarily stored for this charging procedure. To do this, the operator ID and the country ID from this datum can be compared with the list. If an identical entry is present in the list, the EMAID from the list entry can be read out and selected. If no suitable entry is found, the fallback EMAID can be selected, and information relating to an error can further be stored. This procedure takes place, for example, following the set-up of the TLS (Transport Layer Security), but before the authentication by means of the Plug & Charge certificate. The chosen EMAID designates the contract that is then used in the next step on the charging station for authentication during the Plug & Charge authentication.

This list can be defined on the basis of various premises (also in combination), e.g. based on (known) roaming relationships, customer preference (defined by the customer or learnt on the basis of behavior) , with knowledge of the individual prices of a specific EMAID with a specific charging station operator, according to the lowest possible costs for the customer. Other prioritization options are furthermore explicitly possible. The list can either be created locally on the vehicle or can be imported into the vehicle by means of a backend connection and updated. Insofar as communication takes place by means of ISO 15118-20, a comparison can be made with the SupportedProvidersListType. In other words, the control circuit can further be designed to receive a list of supported mobility operators from the charging infrastructure (the SupportedProvidersList Type), and to determine the selection of the charging contract further based on the list of supported mobility operators. The aforementioned list can contain, for example, the same operator ID for a plurality of EMAIDs. The list can be structured, for example, such that a prioritized contract or one or more fallback contracts (EMAIDs) are provided for each operator ID. If the provider of the prioritized EMAID is not part of the SupportedProvidersListType, a fallback contract can be chosen.

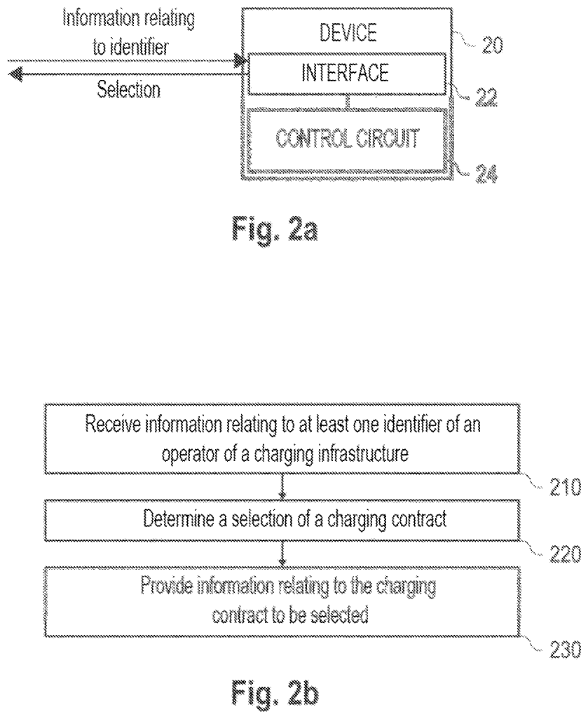

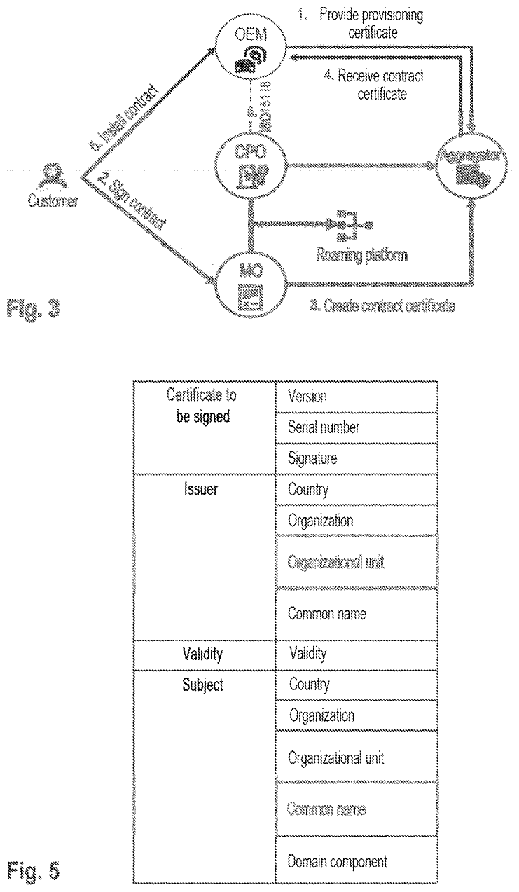

The list which predefines the automatic selection in the charging controller can be created, for example, user-specifically in the backend and can be imported via a remote connection into the charging controller. The list itself can be created on the basis of customer specifications (individual prioritization of the contracts depending on the charging station operator), existing restrictions (e.g. due to roaming of specific contracts with specific stations), taking into account the most favorable price or other criteria or a combination thereof. A customer-defined contract, which is intended to be used if an automatic selection of the contract is not possible, can be used as a fallback contract. In many cases, the charging contract can be selected by the control circuit. Alternatively, instead of the charging controller, a plurality of controllers which communicate with one another in the vehicle can be involved in the automatic contract selection. Correspondingly, determining the selection can comprise providing a remote station with information relating to the at least one identifier (e.g. via the at least one interface 12), and receiving information relating to the charging contract to be selected from the remote station (e.g. via the at least one interface 12). The remote station can be a further controller 105 of the vehicle or a backend server 205. FIG. 2a and FIG. 2b show examples of a device, a method and a computer program which perform the selection on the remote station. The list can thus be located, for example, on a different controller or on the backend server, and, before the authentication by means of the operator ID and country ID/code, the charging controller queries, via a vehicle network, which EMAID is to be used for this combination. The controller on which the list is stored takes charge of the comparison and sends the selected EMAID, and optionally a fallback EMAID also, back to the charging controller. In a further configuration, the charging controller or a different controller which communicates with the charging controller can query the preferred EMAID (and fallback EMAID) before each charging procedure following the identification of the operator ID and country ID/code in the backend.

### During the Authentication of the Charging Controller (e.g.

via the at least one interface 12), the certificate of the selected charging contract is then used to cryptographically secure the communication with the charging infrastructure 5 and to identify, and therefore authenticate, the charging controller with respect to the charging infrastructure.

Following the authentication, a message can be sent from the charging controller to the backend, containing, for example, (at least) the following information: EVSEID, CPID, SECCID, EMAID that is used, automatic selection successful, authentication successful. In other words, the control circuit can further be designed, at least in the event that the authentication fails, to transmit information relating to the at least one identifier, relating to the selected charging contract and relating to the success or failure of the authentication to a backend server 205. This information can be used, on the one hand, to indicate errors transparently to the customer, e.g. in a mobile application of the vehicle manufacturer. On the other hand, this information can be used to improve the automatic selection mechanism, in particular the aforementioned list.

The at least one interface 12 can correspond, for example, to one or more inputs and/or to one or more outputs for receiving and/or transmitting information, e.g. in digital bit values, based on a code, within a module, between modules, or between modules of different entities. In exemplary embodiments, the control circuit 16 can correspond to any controller or processor or to a programmable hardware component. The control circuit 16 can also be implemented, for example, as software that is programmed for a corresponding hardware component. In this respect, the control circuit 16 can be implemented as programmable hardware having correspondingly adapted software. Any processors, such as digital signal processors (DSPs), can be used. Exemplary embodiments are not restricted to a specific type of processor. Any processors or even a plurality of processors are conceivable for the implementation. In some examples, the control circuit 16 can comprise the cryptographically secured element 14.

The memory 18 of the charging controller can comprise at least one element from the group comprising: computer-readable storage medium, magnetic storage medium, optical storage medium, hard disk, flash memory, diskette, random access memory, programmable read-only memory (PROM), erasable programmable read-only memory (EEPROM), electronically erasable programmable read-only memory (EEPROM), and network memory.

The vehicle 100 can correspond, for example, to a land vehicle, a watercraft, an aircraft, a rail vehicle, a road vehicle, an automobile, an off-road vehicle, a motor vehicle, or a truck.

More details and aspects of the charging controller, the corresponding method and the computer program will be mentioned in connection with the disclosure and/or examples described below (e.g. FIG. 2a to 4). The charging controller, the corresponding method and the computer program can comprise one or more additional optional features corresponding to one or more aspects of the proposed disclosure or the described examples, as set out above or below.

FIG. 2a shows a schematic diagram of a device 20 for determining a selection of a charging contract. The device 20 comprises at least one interface 22 for communicating with a charging controller 10 (shown in FIG. 1a) of the vehicle. The device comprises a control circuit 24 which is coupled to the at least one interface 22. The control circuit 24 is designed to receive information relating to at least one identifier of an operator of a charging infrastructure from the charging controller (via the interface 22). The control circuit 24 is designed to determine a selection of a charging contract from a plurality of charging contracts stored in the charging controller based on the operator of the charging infrastructure. The control circuit 24 is designed to provide a charging controller with information relating to the charging contract to be selected (via the interface 22). The device 20 can be part of a controller (e.g. the controller 200 in FIG. 1a) or part of a backend server (e.g. the backend server 205 in FIG. 1a).

FIG. 2b shows a flow diagram of a corresponding method for determining the selection of the charging contract. The method comprises receiving 210 information relating to the at least one identifier of the operator of the charging infrastructure from the charging controller. The method comprises determining 220 the selection of the charging contract from the plurality of charging contracts stored in the charging controller based on the operator of the charging infrastructure. The method comprises providing 230 the charging controller with information relating to the charging contract to be selected.

The selection of the charging contract performed by the device 20 from FIG. 2a and by the method from FIG. 2b (and by a corresponding computer program) can be carried out, for example, in a manner similar to the selection of the charging contract as described in connection with Fig. la and FIG. 1b.

The at least one interface 22 can correspond, for example, to one or more inputs and/or outputs for receiving and/or transmitting information, e.g. in digital bit values, based on a code, within a module, between modules, or between modules of different entities.

In exemplary embodiments, the control circuit 24 can correspond to any controller or processor or to a programmable hardware component. The control circuit 24 can also be implemented, for example, as software that is programmed for corresponding hardware component. In this respect, the control circuit 24 can be implemented as programmable hardware having correspondingly adapted software. Any processors, such as digital signal processors (DSPs), can be used. Exemplary embodiments are not restricted to a specific type of processor. Any processors or even a plurality of processors are conceivable for the implementation.

More details and aspects of the charging controller, the corresponding method and the computer program will be mentioned in connection with the disclosure and/or examples described below (e.g. FIG. 1a to 1b, 3 to 4). The device, the corresponding method and the computer program can comprise one or more additional optional features corresponding to one or more aspects of the proposed disclosure and/or the described examples, as set out above or below.

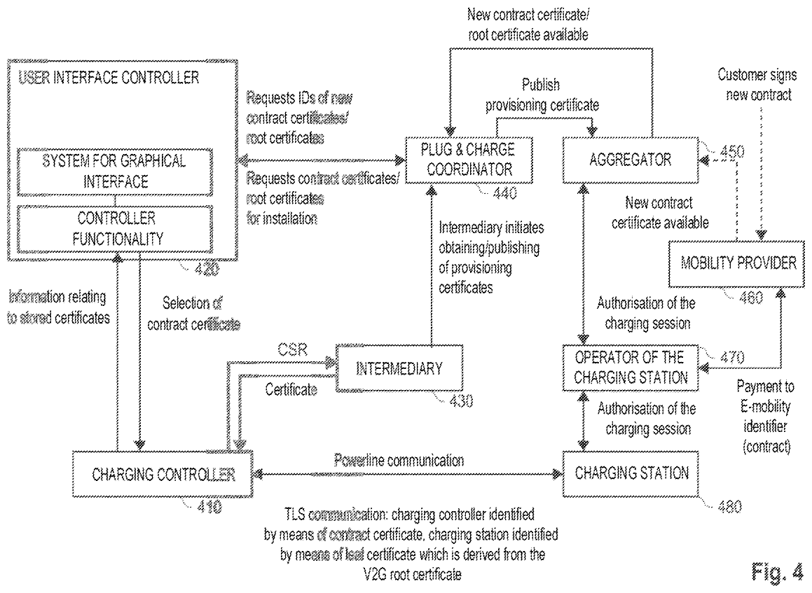

A brief overview of the mechanisms of Plug & Charge as used in the present disclosure is provided below for further understanding. Plug & Charge enables a fully automatic and secure charging experience by means of the authentication technology of EV to charging station (in accordance with ISO 15118). FIG. 3 shows a schematic diagram of Plug & Charge from a technical perspective. First (1.), the vehicle manufacturer (shown as OEM in FIG. 4) provides a provisioning certificate to an aggregator. In the present case, this provisioning certificate comprises a user-account-specific, unique identifier. The vehicle user then concludes a charging contract with the mobile operator (MO). When concluding the charging contract, the vehicle user notifies the vehicle identification number (e.g. the PCID), which can be done, for example, through the manufacturer. The mobility operator creates a contract certificate (3.) for the indicated vehicle identification number and similarly provides it to the aggregator. The aggregator informs the OEM (4.) that it has received a contract certificate and optionally forwards it to the OEM (or the contract certificate is retrieved, if required, by the OEM). The customer instructs the vehicle manufacturer, and, in particular, the vehicle, to download and install the contract certificate (5.). During the charging procedure, the vehicle manufacturer or the vehicle communicates (6.) via ISO 15118 with the charging point operator (CPO) which can then in turn make contact with the mobile operator via the aggregator and/or a roaming platform regarding the payment for the charging procedure.

FIG. 4 shows a simplified representation of the technical infrastructure for the use of Plug & Charge. FIG. 4 shows a charging controller 410, which can correspond to the charging controller 10 from FIG. 1a, a user interface charging controller 420, which can correspond to the controller 200 from FIG. 1a, an intermediary 430 (which can be used in the vehicle or in the manufacture of the vehicle), a Plug & Charge coordinator 440 (on the vehicle manufacturer side), an aggregator 450, a mobility provider 460, an operator of the charging station 480, and the charging station 480. The charging controller 410 is designed for communication in accordance with ISO 15118 and is responsible for the storage and handling of the certificate (including diagnostic tasks). The intermediary is the root certificate authority of the vehicle manufacturer and provides provisioning certificates.

The following steps can be carried out in order to install a new contract in the vehicle, and, in particular, in the charging controller. A provision certificate is typically required in order to enable the installation of charging contracts (or the corresponding certificates). In the present example, this is carried out by the intermediary 430. The intermediary 430 receives Certificate Signing Request (CSR) from the charging controller, and provides the charging controller 410 with a private key of the certificate, and provides the Plug & Charge coordinator 440 with a public key. This coordinator publishes the provision certificate (i.e. the public key thereof) in the aggregator 450. The provision certificate contains a cryptographically secured identifier of the vehicle (e.g. chassis number).

If a customer signs a charging contract, the customer indicates the identifier of the vehicle with respect to the mobility provider 460 as part of the contract. The mobility provider 460 creates a new contract certificate. The contract certificate can then be encrypted by means of the provision certificate (i.e. the public key), so that it can be decrypted only by a charging controller which has the private key of the provisioning certificate. The appropriate provision certificate is determined by means of the identifier (i.e. the unique identifier). The aggregator 450 receives the encrypted contract certificate and informs the Plug & Charge coordinator 440 thereof. The coordinator 440 can then receive the contract certificate and provide it to the charging controller (e.g. via a telematics connection). Alternatively, the contract certificate can be exchanged between the charging station 480 and the charging controller 410 using power line communication. If the charging controller has a corresponding contract certificate, it can identify itself by means of the contract certificate via a connection which is secured by means of a TLS (Transport Layer Security) communication. The charging station identifies itself by means of a leaf certificate which is derived from a V2G (Vehicle-to-Grid) root certificate. A TLS (e.g. a TLS 1.2) connection is first set up between the charging station and the vehicle by means of the leaf certificate of the charging station (similar to transport encryption on the Internet). The contract certificate is then transmitted. The contract certificate is therefore not part of the TLS chain. In the case of TLS 1.3, a further certificate is used, which is described in ISO 15518-20. The authorization of the charging session is performed between the charging station 480, the operator of the charging station 480, and the aggregator 450, wherein the operator 470 of the charging station can determine the mobility provider 460 via the aggregator 450. The payment is then made to the mobility provider 460, under the terms of the contract, by means of an E-mobility identifier.

The user interface controller comprises a system for a graphical interface which can be based, for example, on a graphical operating system for mobile devices and can enable the on-board user guidance, as well as the configuration of the vehicle and the Plug & Charge functionality, and also the actual controller functionality. The latter communicates with the charging controller 410 and receives information from the charging controller 410 relating to provisioning certificates and contract certificates stored there. A facility for selecting one of the stored certificates can then be provided by means of the system for the graphical interface, wherein the selection is communicated to the charging controller. The user interface controller 420 further requests identifiers of new contract certificates (and V2G root certificates) from the Plug Charge coordinator 440 in order to be able to offer the installation of the contract certificates. If the installation is instigated, the user interface controller 420 requests the respective certificates for the installation from the Plug & Charge coordinator. These certificates are then forwarded to the charging controller. A diagnostic communication, for example, and/or a status/configuration communication can be used for the communication between the user interface controller 420 and the charging controller 410.

FIG. 5 shows a diagram of an example of fields of certificate as used in connection with an EVSE/CPO certificate chain of the ISO 15118-2 or ISO 15118-20 standards. These certificates are compliant with the X.509v3 standard. The certificates comprise the tbsCertificate (to-be-signed certificate) segment having the version, serial number and signature fields, the issuer field segment having the country, organization, organizational unit and common name fields, the validity and subject segments having the country, organization, organizational unit, common name and domain component fields. The CPO Sub 1 (charging point operator sub-certificate 1), CPO Sub 2 (charging point operator sub-certificate 2) certificates and the SECC certificate (as leaf certificate), for example, can be used in the certificate chain. Of the fields, the country, organization and common name fields of the issuer and subject segments are of particular interest for determining the at least one identifier. The CPID corresponds to the common name in the subject segment of a leaf certificate in accordance with ISO 15118-2. Only the CPID is defined in the standard is therefore the most promising indicator. However, other indicators can also be used.

The aspects and features which are described in connection with one specific example from the previous examples can also be combined with one or more of the further examples in order to replace an identical or similar feature of this further example or to additionally introduce the feature into the further example.

Examples can further be or relate to a (computer) program having a program code to carry out one or more of the above methods when the program is executed on a computer, a processor or other programmable hardware component. Steps, operations or processes of various of the methods described above can therefore also be carried out by programmed computers, processors or other programmable hardware components. Examples can also cover program memory devices, e.g. digital data storage media which are machine-readable, processor-readable or computer-readable and encode or contain machine-executable, processor-executable or computer-executable programs and instructions. The program memory devices can comprise or be, for example, digital memories, magnetic storage media such as, for example, magnetic disks and magnetic tapes, hard disk drives or optically readable digital data storage media. Further examples can also cover computers, processors, control units, (field-)programmable logic arrays ((F)PLAS), (field-)programmable gate arrays ((F)PGAs), graphics processor units (GPUs), application-specific integrated circuits (ASICs), integrated circuits (ICs) or systems-on-a-chip (SoCs), which are programmed to carry out the steps of the methods described above.

It is further obvious that the disclosure of a plurality of steps, processes, operations or functions is not to be interpreted as invariably requiring their performance in the described sequence, unless this is explicitly indicated in individual cases or is absolutely necessary for technical reasons. The performance of a plurality of steps or functions is not therefore restricted by the preceding description to a specific sequence. In further examples, a single step, a single function, a single process or a single operation can further include or be divided up into a plurality of partial steps, functions, processes or operations.

If some aspects have been described in the preceding sections in connection with a device or a system, these aspects are also to be understood as a description of the corresponding method. A block, a device or a functional aspect of the device or of the system, for example, can correspond to a method step of the corresponding method. Aspects described in connection with a method are also to be understood accordingly as a description of a corresponding block, a corresponding element, a characteristic or a functional feature of a corresponding device or of a corresponding system.

The following claims are incorporated herewith into the detailed description, wherein each claim can stand as a separate example in itself. It should further be noted that, even if a dependent claim refers in the claims to a specific combination with one or more other claims, other examples can also comprise a combination of the dependent claim with the subject-matter of any other dependent or independent claim. Such combinations are explicitly proposed herewith, unless it is indicated in individual cases that a specific combination is not intended. Features of one claim are further intended to be included in any other independent claim, even if this claim is not directly defined as dependent on this other independent claim.

### Reference sign list

5 Charging infrastructure
10 Charging controller
12 Interface
14 Cryptographically secured element
16 Control circuit
18 Memory
20 Device
22 Interface
24 Control circuit
100 Vehicle
110 Process a communication message from a charging infrastructure
120 Determine at least one identifier of an operator of the charging infrastructure based on the communication message
130 Determine a selection of a charging contract from a plurality of charging contracts stored in the charging controller based on the operator of the charging infrastructure
140 Authenticate the charging controller with respect to the charging infrastructure based on the selected charging contract
200 Controller
205 Backend server
210 Receive information relating to at least one identifier of an operator of a charging infrastructure from a charging controller
220 Determine a selection of a charging contract from a plurality of charging contracts stored in the charging controller based on the operator of the charging infrastructure
230 Provide the charging controller with information relating to the charging contract to be selected
410 Charging controller
420 User interface controller
430 Intermediary
440 Plug & Charge coordinator
450 Aggregator
460 Mobility provider
470 Operator of a charging station
480 Charging station

1-17. (canceled)

18. A charging controller for a vehicle, the charging controller comprising:
at least one interface for communication with a charging infrastructure; and
a control circuit configured to:
process a communication message from the charging infrastructure, determine at least one identifier of an operator of the charging infrastructure based on the communication message,
determine a selection of a charging contract from a plurality of charging contracts stored in the charging controller based on the operator of the charging infrastructure, and
authenticate the charging controller with respect to the charging infrastructure based on the selected charging contract.

19. The charging controller as claimed in claim 18, wherein the communication message is a message received during a connection set-up between the charging infrastructure and the charging controller.

20. The charging controller as claimed in claim 19, wherein the control circuit is designed to extract the at least one identifier from a leaf certificate that is used by the charging infrastructure, or from a different certificate of a certificate chain which comprises the leaf certificate.

21. The charging controller as claimed in claim 20, wherein the at least one identifier comprises at least one of a Supply Equipment Communication Controller, SECCID, and a Charge Point Identifier, CPID.

22. The charging controller as claimed in claim 21, wherein the at least one identifier comprises an Electric Vehicle Supply Equipment Identifier, EVSEID.

23. The charging controller as claimed in claim 22, wherein the control circuit is designed to determine a plurality of identifiers based on the communication message and, depending on the operator, to use one or more of the identifiers to identify the operator.

24. The charging controller as claimed in claim 23, wherein the selection is determined based on a data structure, wherein a charging contract to be selected is defined in the data structure for a plurality of operators.

25. The charging controller as claimed in claim 24, wherein a charging contract which is to be selected when no charging contract to be selected is defined for an operator is defined in the data structure.

26. The charging controller as claimed in claim 25, wherein the charging contract is selected by the control circuit.

27. The charging controller as claimed in claim 25, wherein determining the selection comprises providing a remote station with information relating to the at least one identifier, and receiving information relating to the charging contract to be selected from the remote station, wherein the remote station is a further controller of the vehicle or a backend server.

28. The charging controller as claimed in claim 27, wherein the control circuit is further designed to receive a list of supported mobility operators from the charging infrastructure, and to determine the selection of the charging contract further based on the list of supported mobility operators.

29. The charging controller as claimed in claim 28, wherein the control circuit is further configured, at least in an event that the authentication fails, to transmit information relating to the at least one identifier, relating to the selected charging contract, and relating to success or failure of the authentication to a backend server.

30. The charging controller as claimed in claim 29, wherein the charging contracts and a communication with the charging infrastructure are based on ISO 15118 standard.

31. A method for operating a charging controller for a vehicle, the method comprising:
processing a communication message from a charging infrastructure;
determining at least one identifier of an operator of the charging infrastructure based on the communication message;
determining a selection of a charging contract from a plurality of charging contracts stored in the charging controller based on the operator of the charging infrastructure; and
authenticating the charging controller with respect to the charging infrastructure based on the selected charging contract.

32. The method as claimed in claim 31, the method further comprising connecting a charging cable of a charging point to a charging interface of the vehicle prior to processing the communication message from the charging infrastructure.

33. The method as claimed in claim 32, the method further comprising, after authenticating the charging controller, charging a battery of the vehicle from the charging point via the charging cable.

34. A non-transitory computer-readable medium comprising instructions to carry out the method as claimed in claim 32 when the instructions are executed on a computer, a processor, a control module, a control circuit or a programmable hardware component.

35. A method for determining a selection of a charging contract for a vehicle, comprising:
receiving information relating to at least one identifier of an operator of a charging infrastructure from a charging controller;
determining a selection of a charging contract from a plurality of charging contracts stored in the charging controller based on the operator of the charging infrastructure; and
providing the charging controller with information relating to the charging contract to be selected.

36. The method as claimed in claim 35, wherein a charging cable of a charging point is connected to a charging interface of the vehicle prior to receiving information relating to at least one identifier of the operator of the charging infrastructure, the method further comprising, after providing the charging controller with information relating to the charging contract to be selected, charging a battery of the vehicle from the charging point via the charging cable.

37. A non-transitory computer-readable medium comprising instructions to carry out the method as claimed in claim 35 when the instructions are executed on a computer, a processor, a control module, a control circuit or a programmable hardware component.
